(19) United States
(12) Patent Application Publication
(10) Pub. No.: US 2005/0191532 A1
(43) Pub. Date: Sep. 1, 2005

(54) Reformer for fuel cell system and fuel cell system having the same

(76) Inventors: Ju-Yong Kim, Suwon-si (KR); Hyoung-Juhn Kim, Suwon-si (KR); Yeong-Chan Eun, Suwon-si (KR); Seong-Jin An, Suwon-si (KR); Sung-Yong Cho, Suwon-si (KR); Dong-Hun Lee, Suwon-si (KR); Hae-Kwon Yoon, Suwon-si (KR); Ho-Jin Kweon, Suwon-si (KR)

Correspondence Address: Robert E. Bushnell, Suite 300, 1522 K Street, N. W., Washington, DC, 20005-1202, US

(21) Appl. No.: 11/065,583

(22) Filed: Feb. 25, 2005

(30) Foreign Application Priority Data
Feb. 26, 2004 (KR) 10-2004-0012958

(51) Int. Cl. H01M 8/06; F28D 7/10

(52) U.S. Cl. 429/19; 422/198; 48/61

(57) ABSTRACT

A fuel cell system that includes at least one electricity generator that generates electric energy through electrochemical reaction between hydrogen and oxygen, a reformer that generates hydrogen gas by reforming fuel containing hydrogen and supplies the hydrogen gas to the electricity generator, a fuel supply unit which supplies the fuel to the reformer, and an oxygen supply unit which supplies oxygen to the electricity generator and the reformer. The reformer includes a double pipe lines that are arranged concentrically and have independent flow paths through which fuel passes, and catalytic layers that are formed in the flow paths, generate thermal energy through chemical catalytic reaction, and generate hydrogen gas from the fuel.

### CLAIM OF PRIORITY

This application makes reference to, incorporates the same herein, and claims all benefits accruing under 35 U.S.C. §119 from an application for REFORMER FOR FUEL CELL SYSTEM AND FUEL CELL SYSTEM HAVING THE SAME earlier filed in the Korean Intellectual Property Office on 26 Feb. 2004 and there duly assigned Serial No. 10-2004-0012958.

### BACKGROUND OF THE INVENTION

1. Field of the Invention

The present invention relates to a fuel cell system, and more particularly, to a fuel cell system having a reformer with an improved structure.

2. Description of the Related Art

A fuel cell is an electric-power generating system in which chemical reaction energy between oxygen and hydrogen contained in hydrocarbon material such as methanol, ethanol, and natural gas is directly converted into electric energy. Depending on types of electrolyte used in fuel cells, the fuel cells are classified into a phosphate fuel cell, a molten carbonate fuel cell, a solid oxide fuel cell, a polymer electrolyte or alkali fuel cell, etc. These different types of fuel cells basically work using the same principles, but are different from one another in kinds of fuel used, operating a temperature, catalyst, and electrolyte.

A polymer electrolyte membrane fuel cell (PEMFC) developed recently has an excellent output characteristic, a low operating temperature, and fast starting and response characteristics in comparison with other fuel cells. The PEMFC can be widely applied to mobile power sources used for vehicles, distributed power sources used for homes and buildings, small power sources used for electronic appliances, and the like.

The PEMFC basically is made up of a stack, a reformer, a fuel tank, and a fuel pump to constitute a system. The stack forms a main body of the fuel cell. The fuel pump supplies fuel from the fuel tank to the reformer. The reformer reforms the fuel to generate hydrogen gas and supplies the hydrogen gas to the stack. Accordingly, the PEMFC supplies the fuel from the fuel tank to the reformer through operation of the fuel pump and reforms the fuel using the reformer to generate hydrogen gas. Then, the stack generates electric energy through electrochemical reaction between the hydrogen gas and oxygen.

The stack is an apparatus for generating thermal energy through chemical catalytic reaction between the fuel and air and for absorbing the thermal energy to generate the hydrogen gas from the fuel. The reformer of the conventional fuel cell system utilizes exothermic reaction and endothermic reaction with a catalyst. Therefore, the reformer is made up of a heat-emitting portion for generating thermal energy through oxidation catalytic reaction between fuel and air and a heat-absorbing portion for receiving the thermal energy and generating hydrogen gas from the fuel through reformation catalytic reaction.

However, in the conventional reformer, since the heat-emitting portion and the heat-absorbing portion are provided separately and the heat generated from the heat-emitting portion is transferred to the heat-absorbing portion, heat exchange between the heat-emitting portion and the heat-absorbing portion is not directly performed, so that there is a disadvantage in heat transfer. Moreover, since the heat-emitting portion and the heat-absorbing portion are provided separately, there is also a disadvantage that the whole size of the system cannot be reduced to a compact size.

### SUMMARY OF THE INVENTION

It is therefore an object of the present invention to provide an improved fuel cell system.

It is also an object of the present invention to provide for improved designs for reformers in a fuel cell system.

It is also an object of the present invention to provide a fuel supply system and a reformer for the fuel supply system that is both compact in size and can transfer heat rapidly between a heat-emitting portion and a heat-absorbing portion.

These and other objects can be achieved by a fuel supply system and a reformer for a fuel cell system where the reformer includes a double pipe line has independent flow paths through which fuel passes, and catalytic layers which are formed in the flow paths and generate thermal energy through chemical catalytic reaction, and generate hydrogen gas from the fuel.

In the reformer for a fuel cell system according to the present invention, the catalytic layers may include an oxidation catalytic layer that generates the thermal energy through oxidation reaction between the fuel and air, and a reformation catalytic layer that generates the hydrogen gas from the fuel through reformation reaction of steam by absorption of the thermal energy.

In order to accomplish the above object, according to another aspect of the present invention, there is provided a reformer for a fuel cell system, the reformer includes a first pipe line, a second pipe line which has a sectional area smaller than that of the first pipe line and is located at the inner central side of the first pipe line, an oxidation catalytic layer formed on one wall surface of an inner wall surface and an outer wall surface of the second pipe line, and a reformation catalytic layer formed on the other wall surface of the inner wall surface and the outer wall surface.

In the reformer for a fuel cell system according to the present invention, the oxidation catalytic layer may be formed on the inner wall surface of the second pipe line and the reformation catalytic layer may be formed on the outer wall surface of the second pipe line. In this case, in the reformer for a fuel cell system according to the present invention, a first flow path through which the fuel and air pass may be formed inside the second pipe line, and a second flow path through which the fuel passes may be formed between the first pipe line and the second pipe line.

In the reformer for a fuel cell system according to the present invention, the oxidation catalytic layer may be formed on the outer wall surface of the second pipe line, and the reformation catalytic layer may be formed on the inner wall surface of the second pipe line. In this case, in the reformer for a fuel cell system according to the present invention, a first flow path through which the fuel and air pass may be formed between the first pipe line and the second pipe line, and a second flow path through which the fuel passes may be formed inside the second pipe line.

In the reformer for a fuel cell system according to the present invention, the first pipe line may be formed in a circular pipe shape and may be made of one material of SUS (Steel Use Stainless) and zirconium having a heat-insulating property. In the reformer for a fuel cell system according to the present invention, the second pipe line may be formed in a circular pipe shape and may be made of at least one of the following materials: aluminum, copper, and iron having a heat-conducting property.

In the reformer for a fuel cell system according to the present invention, a heat-insulating layer may be formed on an inner surface of the first pipe line and made of one of the following materials: polybenzoimidazole, polyetheretherketone, polyphenylenesufide and polyamideimide. In the reformer for a fuel cell system according to the present invention, it is preferable that the oxidation catalytic layer is made of one of platinum (Pt) and ruthenium (Ru). In the reformer for a fuel cell system according to the present invention, the reformation catalytic layer may be made of either copper (Cu), nickel (Ni) or platinum (Pt).

In order to accomplish the above object, according to another aspect of the present invention, there is provided a fuel cell system that includes one electricity generator which generates electric energy through electrochemical reaction between hydrogen and oxygen, a reformer that generates hydrogen gas by reforming fuel containing hydrogen and supplies the hydrogen gas to the electricity generator, a fuel supply unit that supplies the fuel to the reformer, and an oxygen supply unit that supplies oxygen to the electricity generator and the reformer. The reformer includes a double pipe line has independent flow paths through which fuel passes, and catalytic layers that are formed in the flow paths, generate thermal energy through chemical catalytic reaction, and generate hydrogen gas from the fuel.

In the fuel cell system according to the present invention, the reformer may include a first pipe line, and a second pipe line which has a sectional area smaller than that of the first pipe line and is disposed at the inner central side of the first pipe line.

In the fuel cell system according to the present invention, the catalytic layers may include an oxidation catalytic layer which is formed on one wall surface of an inner wall surface and an outer wall surface of the second pipe line and generates the thermal energy through oxidation reaction between the fuel and air, and a reformation catalytic layer which is formed on the other wall surface of the inner wall surface and the outer wall surface and generates the hydrogen gas from the fuel through reformation reaction of steam by absorption of the thermal energy.

In the fuel cell system according to the present invention, the oxidation catalytic layer may be formed on the inner wall surface of the second pipe line and the reformation catalytic layer may be formed on the outer wall surface of the second pipe line. In this case, in the fuel cell system according to the present invention, a first flow path through which the fuel and air pass may be formed inside the second pipe line, and a second flow path through which the fuel passes may be formed between the first pipe line and the second pipe line. In the fuel cell system according to the present invention, it is preferable that the fuel supply unit and the oxygen supply unit are connected to the first flow path and the fuel supply unit is connected to the second flow path.

In the fuel cell system according to the present invention, the oxidation catalytic layer may be formed on the outer wall surface of the second pipe line, and the reformation catalytic layer may be formed on the inner wall surface of the second pipe line. In this case, in the fuel cell system according to the present invention, a first flow path through which the fuel and air pass may be formed between the first pipe line and the second pipe line, and a second flow path through which the fuel passes may be formed inside the second pipe line. In the fuel cell system according to the present invention, it is preferable that the fuel supply unit and the oxygen supply unit are connected to the first flow path and the fuel supply unit is connected to the second flow path.

In the fuel cell system according to the present invention, it is also preferable that the first pipe line is made of a heat-insulating material. In the fuel cell system according to the present invention, a heat-insulating layer may be formed on the inner surface of the first pipe line.

In the fuel cell system according to the present invention, the reformer may be formed in a zigzag shape. In this case, the fuel cell system according to the present invention may further include a mounting member having a coupling groove which is coupled in shapes to the reformer. In the fuel cell system according to the present invention, a plurality of the reformers having a line shape may be provided. In this case, the fuel cell system according to the present invention may further include a mounting member having coupling grooves that are coupled in shapes to the respective reformers.

In the fuel cell system according to the present invention, a plurality of the electricity generators may be provided, and the electricity generators may be stacked to form a stack. In the fuel cell system according to the present invention, the fuel supply unit may include a first tank that stores liquid-state fuel containing hydrogen, and a second tank that stores water. In the fuel cell system according to the present invention, the oxygen supply unit may include an air pump that sucks air and supplies the air to the reformer and the electricity generator.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram schematically illustrating the entire structure of a fuel cell system according to an exemplary embodiment of the present invention;

FIG. 2 is an exploded perspective view illustrating a structure of a stack illustrated in FIG. 1;

FIG. 3 is a perspective view illustrating a structure of a reformer according to a first embodiment of the present invention;

FIG. 4 is a cross-sectional view illustrating the reformer illustrated in FIG. 3;

FIG. 5 is an exploded perspective view illustrating a mounting structure of the reformer according to the first embodiment of the present invention;

FIG. 6 is a cross-sectional view illustrating a structure of a reformer according to a second embodiment of the present invention;

FIGS. 7A and 7B are cross-sectional views illustrating a structure of a reformer according to a third and fourth embodiments of the present invention; and

FIG. 8 is an exploded perspective view illustrating a mounting structure of a reformer according to a second embodiment of the present invention.

### DETAILED DESCRIPTION OF THE INVENTION

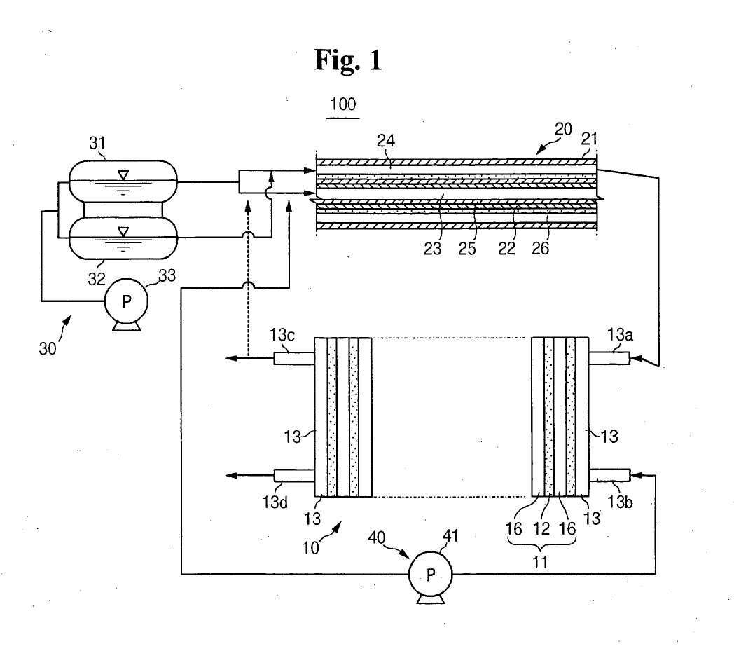

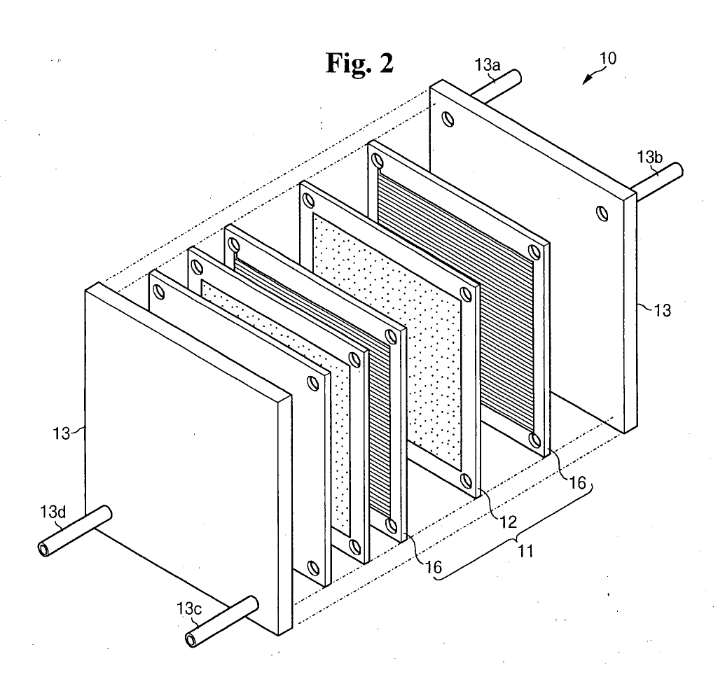

Turning now to the figures, FIG. 1 is a block diagram schematically illustrating the entire structure of a fuel cell system according to an exemplary embodiment of the present invention and FIG. 2 is an exploded perspective view illustrating a structure of a stack 10 illustrated in FIG. 1. The fuel cell system 100 according to the present invention employs a polymer electrolyte membrane fuel cell (PEMFC) scheme in which hydrogen gas is generated by reforming fuel containing hydrogen and electric energy is generated by allowing the hydrogen gas to electrochemically react with oxygen.

The fuel cell system 100 according to the present invention basically includes at least one electricity generator 11 that generates electric energy through electrochemical reaction between hydrogen and oxygen, a reformer 20 that reforms fuel containing hydrogen to generate hydrogen gas and supplies the hydrogen gas to the electricity generator 11, a fuel supply unit 30 that supplies the fuel to the reformer 20, and an oxygen supply unit 40 that supplies oxygen to the electricity generator 11 and the reformer 20, respectively.

The electricity generator 11 forms a minimum unit stack generating electricity by placing separators 16 (also referred to as “bipolar plates”) on both surfaces of a membrane-electrode assembly 12. A plurality of the electricity generators 11 forms the stack 10 having the stacked structure as in the present embodiment. The membrane-electrode assembly 12 has an anode electrode and a cathode electrode on both surfaces thereof and performs oxidation and reduction reaction to the hydrogen gas and oxygen. The separators 16 form pathways for supplying the hydrogen gas and oxygen at both sides of the membrane-electrode assembly 12 and serve as electric conductors for connecting the anode electrode and the cathode electrode in series.

As illustrated in the figures, pressing plates 13 for closely pressing the plurality of electricity generators 11 disposed at the outermost of the stack 10. However, in the stack 10 according to the present invention, the separators 16 positioned at the outermost of the plurality of electricity generators 11 may serve as the pressing plates 13. The pressing plates 13 may have a function specific to the separators 16 in addition to the function of closely pressing the plurality of electricity generators 11.

The pressing plates 13 have a first injecting portion 13a through which the hydrogen gas supplied from the reformer 20 is injected into the electricity generator 11, a second injecting portion 13b through which the air supplied from the oxygen supply unit 40 is injected into the electricity generator 11, a first discharging portion 13c through which the remaining hydrogen gas after reaction in the anode electrode of the membrane-electrode assembly 12 is discharged, and a second discharging portion 13d through which the remaining air after reaction in the cathode electrode of the membrane-electrode assembly 12 and moisture generated from the coupling reaction between hydrogen and oxygen are discharged.

The reformer 20 according to the present invention generates thermal energy through oxidation catalytic reaction between liquid-state fuel and air, and generates the hydrogen gas from the mixed fuel through steam reformer (SR) catalytic reaction with the thermal energy. The fuel supply unit 30 supplying the fuel to the reformer 20 described above includes a first tank 31 that stores the liquid fuel, a second tank 32 that stores water, and a fuel pump 33 that is connected to the first and second tanks 31 and 32, respectively. The oxygen supply unit 40 includes an air pump 41 that sucks air with a predetermined pumping force and supplies the air to the reformer 20 and the electricity generator 11, respectively.

During operation of the fuel cell system 100 according to the present invention described above, when the hydrogen gas generated from the reformer 20 and the air sucked by the air pump 41 are supplied to the electricity generator 11, the electricity generator 11 generates electricity, water and heat through the electrochemical reaction between hydrogen and oxygen.

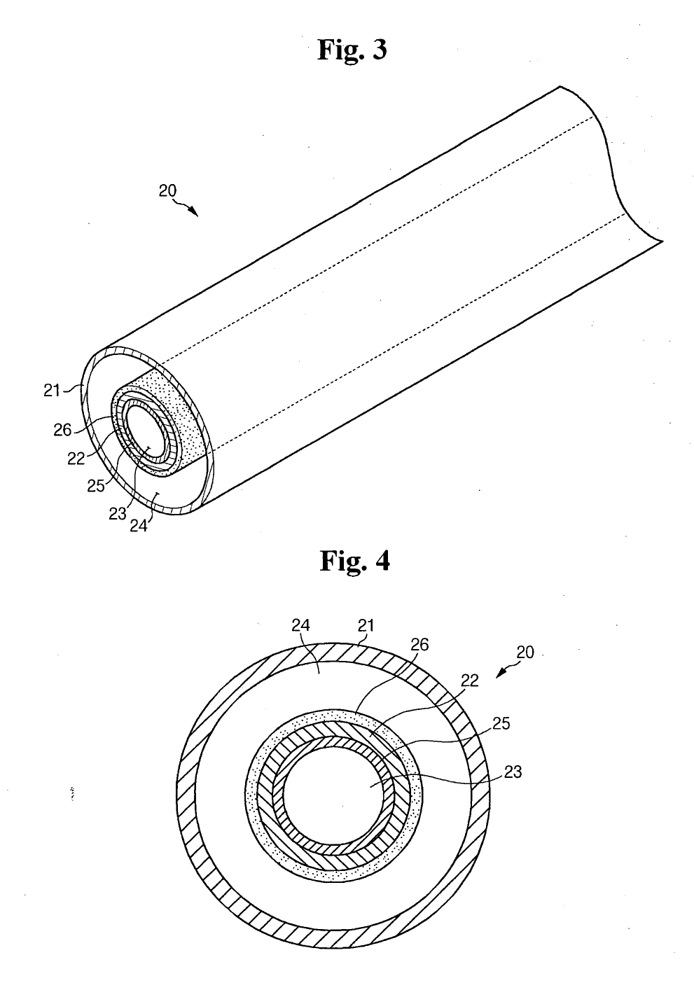

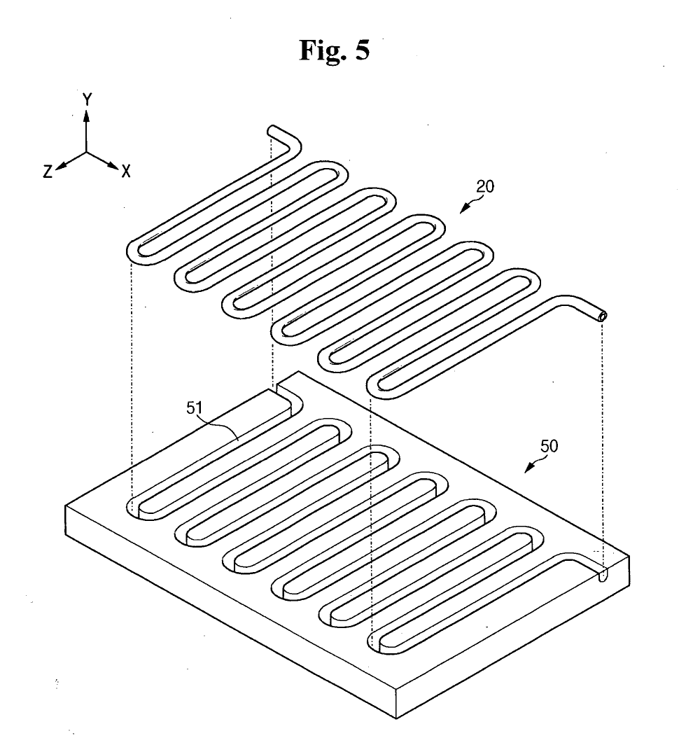

Embodiments of the reformer 20 according to the present invention will now be described in detail with reference to the attached drawings. Turning to FIGS. 3 and 4, FIG. 3 is a partial perspective view illustrating a structure of the reformer according to a first embodiment of the present invention and FIG. 4 is a cross-sectional view of the reformer illustrated in FIG. 3. Referring to the figures, the reformer 20 according to the present invention generates thermal energy through oxidation catalytic reaction between the liquid-state fuel supplied from the fuel supply unit 30 and the air supplied from the oxygen supply unit 40. The reformer 20 absorbs the thermal energy and generates hydrogen gas from the mixed fuel through the steam reformer catalytic reaction of the mixed fuel supplied from the fuel supply unit 30. The reformer 20 has a double pipe shape in which independent inner spaces for passing the fuel are formed.

Specifically, the reformer 20 according to the present embodiment is made up of a first pipe line 21, a second pipe line 22 positioned inside the first pipe line 21, an oxidation catalytic layer 25 formed on the inner wall surface of the second pipe line 22, an a reformation catalytic layer 26 formed on the outer wall surface of the second pipe line 22.

The first pipe line 21 is formed in a circular pipe shape and has a predetermined inner diameter and of which both ends are opened. The first pipe line 21 may be made of heat-insulating material having a relatively small thermal conductivity, for example, metallic heat-insulating material such as stainless steel (SUS), zirconium, etc. or nonmetallic heat-insulating material such as ceramics. The shape of the first pipe line 21 is not limited to the circular pipe shape, and it can be a square or ellipse, etc.

The second pipe line 22 is formed in a circular pipe shape that has a sectional area smaller than that of the first pipe line 21 and of which both ends are opened. The second pipe line 22 is located at the inner central side of the first pipe line 21 such that the outer wall surface thereof is spaced by a constant distance from the inner wall surface of the first pipe line 21. The second pipe line 22 may be made of metal material such as aluminum, copper, iron, etc. having a heat-conducting property. Preferably, the liquid-state fuel and the air pass through the inner space of the second pipe line 22 and mixed fuel of the liquid-state fuel and water passes through the space between the first pipe line 21 and the second pipe line 22. The shape of the second pipe line 22 is not limited to the circular pipe shape, and it can be a square or ellipse, etc.

The oxidation catalytic layer 25 is deposited on the inner wall surface of the second pipe line 22 and is formed by carrying catalytic material such as platinum (Pt), ruthenium (Ru), etc. in carriers including alumina (Al₂O₃), silica (SiO₂), titania (TiO₂), etc. The oxidation catalytic layer 25 performs a function of promoting oxidation reaction between the liquid-state fuel and the air to generate reaction heat of a predetermined temperature.

The reformation catalytic layer 26 is deposited on the outer wall surface of the second pipe line 22 and is formed by carrying catalytic material such as copper (Cu), nickel (Ni), platinum (Pt), etc. in carriers including alumina (Al₂O₃), silica (SiO₂), titania (TiO₂), etc. The reformation catalytic layer 26 performs a function of receiving the thermal energy generated from the inside of the second pipe line 22 to vaporize the mixed fuel and generating hydrogen gas from the vaporized mixed fuel through reformation reaction.

The reformer 20 according to the present embodiment has a double structure of the first pipe line 21 and the second pipe line 22 as a basic structure. Here, a first flow path 23 through which the liquid-state fuel and the air pass is formed inside the second pipe line 22 and a second flow path 24 through which the mixed fuel passes is formed between the first pipe line 21 and the second pipe line 22.

One end of the first flow path 23 may be connected to the first tank 31 and the air pump 41 through a particular pipe. Accordingly, in the second pipe line 22, reaction heat of a predetermined temperature is generated through oxidation reaction between the liquid-state fuel and the air by the oxidation catalytic layer 25 while the liquid-state fuel supplied from the first tank 31 and the air supplied from the air pump 41 pass through the first flow path 23. The combustion gas generated at this time is discharged through the other end of the first flow path 23 and the reaction heat is transferred to the reformation catalytic layer 26 through the second pipe line 22.

One end of the second flow path 24 may be connected to the first and second tanks 31 and 32 through a particular pipe. The other end of the second flow path 24 may be connected to the first injecting portion 13a of the stack 10 through a particular pipe. Accordingly, between the first pipe line 21 and the second pipe line 22, while the mixed fuel of the liquid-state fuel and the water supplied from the first and second tanks 31 and 32 passes through the second flow path 24, hydrogen gas is generated from the mixed fuel through a reformation reaction by the reformation catalytic layer 26 with the thermal energy transferred in the second pipe line 22. At this time, the hydrogen gas is supplied to the first injecting portion 13a of the stack through the other end of the second flow path 24.

Alternatively, between the stack 10 and the reformer 20 of the fuel cell system 100, a normal carbon-monoxide reducing portion (not illustrated), that reduces the concentration of carbon monoxide in the hydrogen gas through water-gas shift (WGS) catalytic reaction or preferential CO oxidation (PROX) catalytic reaction, may be disposed additionally.

FIG. 5 is an exploded perspective view illustrating a mounting structure of the reformer according to the first embodiment of the present invention. As illustrated in FIG. 5, the reformer 20 is formed in a zigzag shape and can be mounted on a particular mounting member 50. A coupling groove 51 enabling the coupling in shapes of the reformer 20 is formed in the mounting member 50.

Alternatively, the fuel cell system 100 according to the present invention may use non-reactive hydrogen gas discharged from the first discharging portion 13c of the stack 10 as the fuel supplied to the first flow path 23 together with the air. For this purpose, the first flow path 23 of the reformer 20 may be connected to the first discharging portion 13c through a predetermined pipe as indicated by a dotted arrow in FIG. 1.

Operation of the fuel cell system according to the first embodiment of the present invention having the aforementioned structure will be described in detail. First, liquid-state fuel stored in the first tank 31 is supplied to the first flow path 23 using the air pump 33. At the same time, air is supplied to the first flow path 23 using the air pump 41. Then, inside the second pipe line 22, while the liquid-state fuel and the air pass through the first flow path 23, reaction heat of a predetermined temperature is generated through oxidation reaction between the liquid-state fuel and the air by the oxidation catalytic layer 25. At this time, the reaction heat is transferred to the reformation catalytic layer 26 through the second pipe line 22.

During this process, the liquid-state fuel stored in the first tank 31 and water stored in the second tank 32 are supplied to the second flow path 24. Then, between the first pipe line 21 and the second pipe line 22, while the mixed fuel of the liquid-state fuel and the water passes through the second flow path 24, hydrogen gas is generated from the mixed fuel through steam reformation reaction by the reformation catalytic layer 26 with the reaction heat.

Subsequently, the hydrogen gas is supplied to the first injecting portion 13a of the stack 10. At the same time, air is supplied to the second injecting portion 13b of the stack 10 using the air pump 41. Then, the hydrogen gas is supplied to the anode electrode of the membrane-electrode assembly 12 through the separators 16. The air is supplied to the cathode electrode of the membrane-electrode assembly 12 through the separators 16.

Therefore, in the anode electrode, the hydrogen gas is decomposed into electrons and protons (hydrogen ions) through oxidation reaction. The protons are moved to the cathode electrode through an electrolyte membrane, and the electrons do not pass through the electrolyte membrane but are moved to the cathode electrode of the membrane-electrode assembly 12 adjacent thereto through the separators 16. At this time, the flow of electrons generates current and heat and water are generated incidentally.

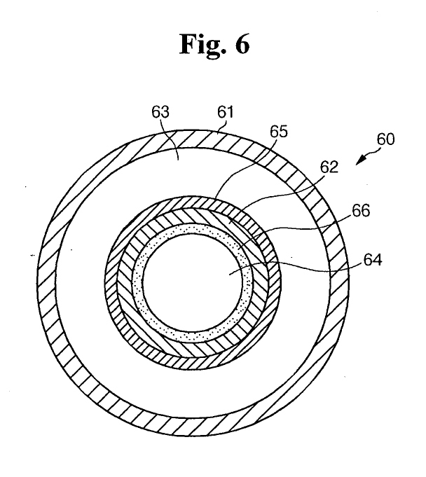

Turning now to FIG. 6, FIG. 6 is a cross-sectional view illustrating a structure of the reformer 60 according to a second embodiment of the present invention. Referring to FIG. 6, the reformer 60 basically has the same double pipe line structure as the first embodiment. The reformer 60 can be constructed by forming an oxidation catalytic layer 65 on the outer wall surface of the second pipe line 62 and forming a reformation catalytic layer 66 on the inner wall surface of the second pipe line 62. In addition, in the reformer 60, a first flow path 63 through which liquid-state fuel and air pass is formed between the first pipe line 61 and the second pipe line 62 and a second flow path 64, through which mixed fuel passes, is formed inside the second pipe line 62.

One end of the first flow path 63 can be connected to the first tank 31 and the air pump 41 illustrated in FIG. 1. One end of the second flow path 64 can be connected to the first and second tanks 31 and 32 illustrated in FIG. 1. The other end of the second flow path 64 can be connected to the first injecting portion 13a of the stack 10 illustrated in FIG. 1.

According to the present embodiment, the liquid-state fuel and the air are supplied to the first flow path 63. Then, between the first pipe line 61 and the second pipe line 62, while the liquid-state fuel and the air pass through the first flow path 63, reaction heat of a predetermined temperature is generated through oxidation reaction between the liquid-state fuel and the air by the oxidation catalytic layer 65. At this time, the reaction heat is transferred to the reformation catalytic layer 66 through the second pipe line 62.

During this process, the mixed fuel is supplied to the second flow path 64. Then, inside the second pipe line 62, while the mixed fuel passes through the second flow path 64, hydrogen gas is generated from the mixed fuel through steam reformation reaction by the reformation catalytic layer 66 with the reaction heat.

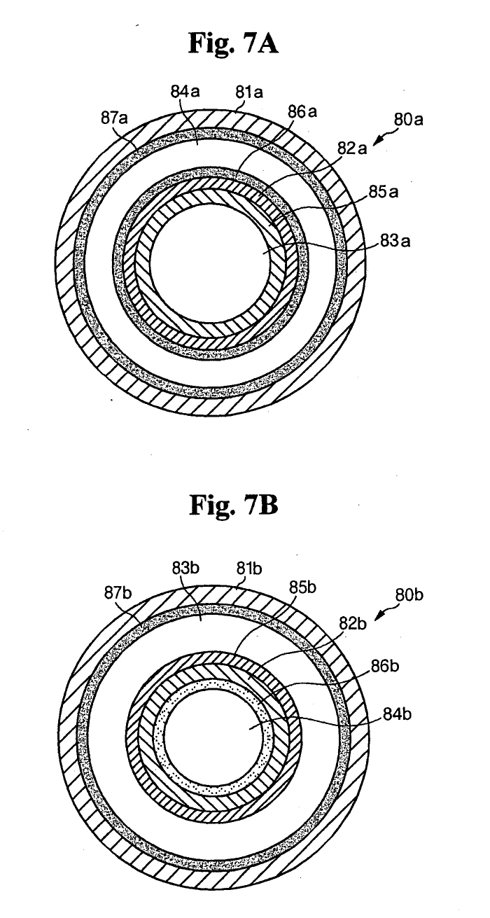

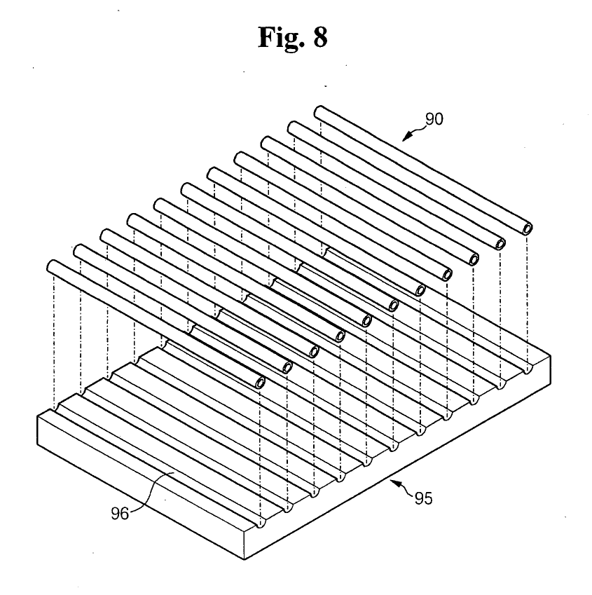

Turning now to FIGS. 7A and 7B, FIGS. 7A and 7B are cross-sectional views illustrating a structure of a reformer 80a and 80b according to third and fourth embodiments of the present invention. Referring to the figures, there is provided the reformer 80 in which a heat-insulating layer 87a or 87b is formed on the inner wall surface of the first pipe line 81a or 81b, unlike the first and second embodiments.

As illustrated in FIG. 7A, the reformer 80a has a double pipe line structure in which the second pipe line 82a is disposed at the inner central side of the first pipe line 81a. The oxidation catalytic layer 85a is formed on the inner wall surface of the second pipe line 82a and the reformation catalytic layer 86a is formed on the outer wall surface of the second pipe line 82a. In the reformer 80a, a first flow path 83a through which liquid-state fuel and air pass is formed inside the second pipe line 82a, and a second flow path 84a through which mixed fuel passes is formed between the first pipe line 81a and the second pipe line 82a.

As illustrated in FIG. 7B, in the reformer 80b, the oxidation catalytic layer 85b is formed on the outer wall surface of the second pipe line 82b and the reformation catalytic layer 86b is formed on the inner wall surface of the second pipe line 82b. In the reformer 80b, a first flow path 83b through which liquid-state fuel and air pass is formed between the first pipe line 81b and the second pipe line 82b, and a second flow path 84b through which mixed fuel passes is formed inside the second pipe line 82b. As described above, the heat-insulating layer 87b may be made of heat-insulating material such as polybenzoimidazole, polyetheretherketone, polyphenylenesufide or polyamideimide.

Turning now to FIG. 8, FIG. 8 is an exploded perspective view illustrating a mounting structure of the reformer according to a second embodiment of the present invention. Referring to FIG. 8, a plurality of reformers 90 having a line shape of a predetermined length and having the same basic structure as those of the first, second and third embodiments. A mounting member 95 that is coupled in shapes to the respective reformers 90 is also provided.

Coupling grooves 96 coupled to the respective reformers 90 are formed in the mounting member 95. Therefore, the respective reformers 90 are coupled to the coupling grooves 96. The other structure of the reformer 90 according to the present embodiment is similar to the aforementioned embodiments and detailed descriptions thereof will be thus omitted. Thus, reformer 90 in FIG. 8 could be the same as reformer 80b of FIG. 7B, reformer 80a of FIG. 7A, reformer 60 of FIG. 6, reformer 20 of FIGS. 3 and 4 or some other reformer.

As described above, in the fuel cell system according to the present invention, since the reformer of a double pipe line shape capable of rapidly transferring thermal energy required for reformation reaction of fuel is provided, it is possible to reduce the initial starting time and the transfer path of the thermal energy of the reformer. Therefore, the thermal efficiency and performance of the entire system can be enhanced and the size of the entire system can be reduced.

Although exemplary embodiments of the present invention have been described in detail hereinabove, it will be understood by those skilled in the art that the present invention is not limited to the exemplary embodiments and various changes in form and details may be made therein without departing from the spirit and scope of the invention as defined by the appended claims.

1. A reformer, comprising:
a double pipe line having independent flow paths through where fuel passes; and
catalytic layers arranged in the flow paths and adapted to generate thermal energy through chemical catalytic reaction, and adapted to generate hydrogen gas from the fuel.

2. The reformer of claim 1, the catalytic layers comprise:
an oxidation catalytic layer adapted to generate the thermal energy through oxidation reaction between the fuel and air; and
a reformation catalytic layer adapted to generate hydrogen gas from the fuel through reformation reaction of steam by absorption of the thermal energy.

3. A reformer, comprising:
a first pipe line;
a second pipe line that has a sectional area smaller than that of the first pipe line and is arranged at an inner central side of the first pipe line;
an oxidation catalytic layer arranged on one wall surface of an inner wall surface and an outer wall surface of the second pipe line; and
a reformation catalytic layer arranged on another wall surface of the inner wall surface and the outer wall surface.

4. The reformer of claim 3, the oxidation catalytic layer being arranged on the inner wall surface of the second pipe line and the reformation catalytic layer being arranged on the outer wall surface of the second pipe line.

5. The reformer of claim 4, a first flow path through where the fuel and air pass is arranged inside the second pipe line and a second flow path through where the fuel passes is arranged between the first pipe line and the second pipe line.

6. The reformer of claim 3, the oxidation catalytic layer being arranged on the outer wall surface of the second pipe line, and the reformation catalytic layer being arranged on the inner wall surface of the second pipe line.

7. The reformer of claim 6, a first flow path through where the fuel and air pass is arranged between the first pipe line and the second pipe line, and a second flow path through where the fuel passes is arranged inside the second pipe line.

8. The reformer of claim 3, the first pipe line being arranged in a circular pipe shape, having a heat-insulating property and comprising a material selected from the group consisting of SUS (Steel Use Stainless) and zirconium.

9. The reformer of claim 3, the second pipe line being arranged in a circular pipe shape, having a heat-conducting property and comprising a material selected from the group consisting of aluminum, copper and iron.

10. The reformer of claim 3, further comprising a heat-insulating layer arranged on an inner surface of the first pipe line, the heat-insulating layer comprising a material selected from the group consisting of polybenzoimidazole, polyetheretherketone, polyphenylenesufide and polyamideimide.

11. The reformer of claim 3, the oxidation catalytic layer comprising a material selected from the group consisting of platinum (Pt) and ruthenium (Ru).

12. The reformer of claim 3, the reformation catalytic layer comprising a material selected from the group consisting of copper (Cu), nickel (Ni) and platinum (Pt).

13. A fuel cell system, comprising:
an electricity generator adapted to generate electric energy through electrochemical reaction between hydrogen and oxygen;
a reformer adapted to generate hydrogen gas by reforming fuel comprising hydrogen and adapted to supply the hydrogen gas to the electricity generator;
a fuel supply unit adapted to supply the fuel to the reformer; and
an oxygen supply unit adapted to supply oxygen to the electricity generator and the reformer, the reformer comprising:
a double pipe line arranged comprising independent flow paths through where fuel passes; and
catalytic layers arranged in the flow paths and adapted generate thermal energy through chemical catalytic reaction and adapted to generate hydrogen gas from the fuel.

14. The fuel cell system of claim 13, the reformer comprises:
a first pipe line; and
a second pipe line having a sectional area that is smaller than a sectional area of the first pipe line, the sectional area of the second pipe line being arranged at an inner central side of the first pipe line.

15. The fuel cell system of claim 14, the catalytic layers comprise:
an oxidation catalytic layer arranged on one wall surface of an inner wall surface and an outer wall surface of the second pipe line and adapted to generate the thermal energy through oxidation reaction between the fuel and air; and
a reformation catalytic layer being arranged on the other wall surface of the inner wall surface and the outer wall surface of the second pipe line, the reformation catalytic layer being adapted to generate the hydrogen gas from the fuel through a reformation reaction of steam by absorption of the thermal energy.

16. The fuel cell system of claim 15, the oxidation catalytic layer being arranged on the inner wall surface of the second pipe line and the reformation catalytic layer being arranged on the outer wall surface of the second pipe line.

17. The fuel cell system of claim 16, further comprising:
a first flow path through where the fuel and air pass, the first flow path being arranged inside the second pipe line; and
a second flow path through where the fuel passes, the second flow path being arranged between the first pipe line and the second pipe line.

18. The fuel cell system of claim 17, the fuel supply unit and the oxygen supply unit are connected to the first flow path and the fuel supply unit is connected to the second flow path.

19. The fuel cell system of claim 15, the oxidation catalytic layer is arranged on the outer wall surface of the second pipe line, and the reformation catalytic layer is arranged on the inner wall surface of the second pipe line.

20. The fuel cell system of claim 19, further comprising:
a first flow path through where the fuel and air pass, the first flow path being arranged between the first pipe line and the second pipe line; and
a second flow path through where the fuel passes, the second flow path being arranged inside the second pipe line.

21. The fuel cell system of claim 20, the fuel supply unit and the oxygen supply unit are connected to the first flow path and the fuel supply unit is connected to the second flow path.

22. The fuel cell system of claim 14, the first pipe line comprises a heat-insulating material.

23. The fuel cell system of claim 14, further comprising a heat-insulating layer arranged on the inner surface of the first pipe line.

24. The fuel cell system of claim 13, the reformer being arranged in a zigzag shape.

25. The fuel cell system of claim 24, further comprising a mounting member having a coupling groove that is coupled in shapes to the reformer.

26. The fuel cell system of claim 13, further comprising a plurality of the reformers, each reformer having a line shape.

27. The fuel cell system of claim 26, further comprising a mounting member having coupling grooves that are coupled in shapes to the respective reformers.

28. The fuel cell system of claim 13, further comprising a plurality of electricity generators, the electricity generators being stacked to form a stack.

29. The fuel cell system of claim 13, the fuel supply unit comprises:
a first tank that stores liquid-state fuel comprising hydrogen; and
a second tank adapted to store water.

30. The fuel cell system of claim 13, the oxygen supply unit comprises an air pump adapted to suck air and to supply the air to the reformer and the electricity generator.
